(19) United States
(12) Patent Application Publication
(10) Pub. No.: US 2008/0191007 A1
(43) Pub. Date: Aug. 14, 2008

(54) Methods and Systems for Identifying Fraudulent Transactions Across Multiple Accounts

(75) Inventor: Denise Keay, Treynor, IA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/677,887

(22) Filed: Feb. 22, 2007

Related U.S. Application Data
(60) Provisional application No. 60/889,594, filed on Feb. 13, 2007.

(51) Int. Cl. G06Q 40/00

(52) U.S. Cl. 235/379

(57) ABSTRACT

According to the invention, a method for identifying suspect financial transactions across multiple accounts is disclosed. The method may include receiving a plurality of data sets. Each data set may relate to a financial transaction, and the plurality of data sets may include a first data set related to a first financial transaction, where the first financial transaction is associated with a first account; and a second data set related to a second financial transaction, where the second financial transaction is associated with a second account. The method may also include flagging the first data set as relating to a fraudulent transaction; analyzing the plurality of data sets according to a first set of criteria, wherein the analysis indicates that the first financial transaction and second financial transaction are similar; and flagging the second data set as relating to a suspect transaction.

### CROSS-REFERENCE TO RELATED APPLICATIONS

This application claims the benefit of U.S. Provisional Application No. 60/889,594, filed Feb. 13, 2007, and entitled “METHODS AND SYSTEMS FOR IDENTIFYING FRAUDULENT TRANSACTIONS ACROSS MULTIPLE ACCOUNTS,” which is hereby incorporated by reference for all purposes in its entirety.

### BACKGROUND OF THE INVENTION

This invention relates generally to the detecting fraudulent financial transactions. More specifically the invention relates to detecting patterns of electronic financial activity that may indicate fraudulent activity occurring in a similar manner on different accounts.

Current methods for detecting fraudulent electronic transactions involve inspecting activity associated with an account for out of the ordinary or suspect transactions in regards to that account only. This may involve scanning account activity for unusual and/or large purchases. For example, a series of small purchases in an account holder's hometown may not be suspicious. Furthermore, the cost of verifying that such transactions are not fraudulent may exceed the loss even if the transaction is fraudulent. But a large transaction in a foreign country on the same day as otherwise normal small expenditures in the account holder's hometown may be suspect. A fraud operations department (also referred to as a fraud checking department) or entity associated either with the institution servicing the account, or the network across which the transaction is handled, may initiate a verification process after the occurrence of such a suspect transaction. The verification process will determine if the account holder authorized the suspect transaction. To complete the verification process, the fraud operations department or entity may communicate directly with the account holder. If the transaction is indeed fraudulent and unauthorized, information required to initiate transactions using the account (i.e. the account number, a PIN code, confidential information held by the account holder, an expiration date of a credit card, or a card security code) may be compromised. The institution servicing the account may then suspend the account before further unauthorized activity occurs and financial loses due to fraud increase.

The method of detecting fraudulent transactions discussed above does not recognize when similar suspect transactions are occurring on multiple accounts. Because the method described focuses on recognizing unusual transactions within a single account, similar fraudulent transactions, possibly initiated by the same criminal party, may not be detected until that transaction is independently examined in light of normal activity on that account. This means more time may lapse before a transaction is determined to be fraudulent, leading to at least the possibility of more financial losses due to fraud. The methods and systems of the present invention provide solutions to these and other problems.

### BRIEF DESCRIPTION OF THE INVENTION

In one embodiment, a method for identifying suspect financial transactions across multiple accounts is provided. The method may include receiving, at a host computer system having a processor, a plurality of data sets, where each data set relates to a financial transaction. The plurality of data sets may include a first data set related to a first financial transaction, where the first financial transaction is associated with a first account; and a second data set related to a second financial transaction, where the second financial transaction is associated with a second account. The method may also include using the host computer system to flag the first data set as relating to a fraudulent transaction. The method may further include analyzing, with the host computer system, the plurality of data sets according to a first set of criteria, where the analysis indicates that the first financial transaction and second financial transaction are similar. The method may also include using the host computer system to flag the second data set as relating to a suspect transaction.

In another embodiment, a method for identifying suspect financial transactions across multiple accounts is provided. The method may include receiving, at a host computer system having a processor, a plurality of data sets, where each data set relates to a financial transaction. The plurality of data sets may include a first data set related to a first financial transaction, where the first financial transaction is associated with a first account; and a second data set related to a second financial transaction, where the second financial transaction is associated with a second account. The method may also include analyzing, with the host computer system, the plurality of data sets according to a first set of criteria, where the analysis indicates that the first financial transaction and second financial transaction are similar. The method may further include using the host computer system to flag the first data set and the second data set as relating to a group of similar transactions. The method may also include determining that the first data set relates to a fraudulent transaction. The method may further include using the host computer system to flag the second data set as relating to a suspect transaction.

In another embodiment, a system for identifying suspect financial transactions across multiple accounts is provided. The system may include a host computer system and a computer readable medium associated with the host computer system. The computer readable medium may include instructions executable by the host computer system to receive a plurality of data sets, where each data set relates to a financial transaction. The plurality of data sets may include a first data set related to a first financial transaction, where the first financial transaction is associated with a first account; and a second data set related to a second financial transaction, where the second financial transaction is associated with a second account. The computer readable medium may also include instructions executable by the host computer system to flag the first data set as relating to a fraudulent transaction. The computer readable medium may further include instructions executable by the host computer system to analyze the plurality of data sets according to a first set of criteria, where the analysis indicates that the first financial transaction and second financial transaction are similar. The computer readable medium may further include instructions executable by the host computer system to flag the second data set as relating to a suspect transaction.

### BRIEF DESCRIPTION OF THE DRAWINGS

The present invention is described in conjunction with the appended figures:

FIG. 1 is a block diagram of a system of the invention for identifying fraudulent transactions across multiple accounts;

FIG. 2 is a block diagram of a portion of the system shown in FIG. 1, except showing the credit processing center, ATM processing center, and fraud operations center in more detail;

FIG. 3A is the first portion of a flow diagram of a method of the invention for identifying fraudulent transactions across multiple accounts;

FIG. 3B is the second portion of a flow diagram of a method of the invention for identifying fraudulent transactions across multiple accounts;

FIG. 4 is an example of suspect transactions data sets stored by a fraud operations center;

FIG. 5 is an example of the data sets from FIG. 4 after information irrelevant to fraud checking has been stripped from the data sets;

FIG. 6 is an example of the data sets from FIG. 5 after additional information relevant to fraud checking has been added to the data sets;

FIG. 7 is an example of the data sets from FIG. 6 with flag, match, and risk fields added;

FIG. 8 is an example of the data sets from FIG. 6 after performing one of the methods of the invention;

FIG. 9 is an example of the data sets from FIG. 8 added after performing another one of the methods of the invention; and

FIG. 10 is a block diagram of an exemplary computer system capable of being used in at least some portion of the apparatuses or systems of the present invention, or implementing at least some portion of the methods of the present invention.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination corresponds to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In one embodiment, a method for identifying suspect financial transactions across multiple accounts is provided. The method may include receiving, at a host computer system having a processor, a plurality of data sets, where each data set relates to a financial transaction. Each data set may include information such as an account identifier, a monetary amount, a transaction entry mode or channel, a type of transaction, a geographic location, an agent identifier, a date, and a time. The transaction mode may, merely by way of example, be a credit mode transaction or an ATM mode transaction. The type of transaction may, merely by way of example, be a cash withdrawal, a transfer of value (i.e. a deposit or payment), a purchase of goods, and/or a purchase of services.

The plurality of data sets may include a first data set related to a first financial transaction, where the first financial transaction is associated with a first account; and a second data set related to a second financial transaction, where the second financial transaction is associated with a second account.

In some embodiments, the method may include receiving at the host computer system a notification that the first data set relates to a fraudulent transaction. This notification may be from another system, or may be input more directly into the system by a user/operator. The method may also include using the host computer system to flag the first data set as relating to a fraudulent transaction. In some embodiments, the host computer system may be used to determine that the first data set relates to a fraudulent transaction. In other embodiments, a person may verify with the account holder that the first data set relates to a fraudulent transaction, possibly over the phone or via electronic transmission such as e-mail. In some embodiments, an automated system may be used to call or electronically contact the account holder.

The method may further include analyzing, with the host computer system, the plurality of data sets according to a first set of criteria, where the analysis indicates that the first financial transaction and second financial transaction are similar. Any number of criteria may be used to analyze the plurality of data sets. For example, possible criteria include: a monetary amount specified by the first data set being within a certain range of a monetary amount specified by the second data set; a transaction mode specified by the first data set being the same as, or related to, a transaction mode specified by the second data set; a type of transaction specified by the first data set being the same as, or related to, a type of transaction specified by the second data set; a geographic location specified by the first data set being within a certain distance of a geographic location specified by the second data set; an agent identifier specified by the first data set being the same as, or related to, an agent identifier specified by the second data set; a date specified by the first data set being within a certain range of a date specified by the second data set; and a time specified by the first data set being within a certain range of a time specified by the second data set.

The method may also include using the host computer system to flag the second data set as relating to a suspect transaction, possibly if certain criteria are met or indicate similarities between the data sets. In some embodiments, the method may also include transmitting from the host computer system a notification that the second data set relates to a suspect transaction. This transmission may direct other systems or to user/operators to block the transaction, conduct further investigation into the transaction, and/or queue the transaction for further investigation.

In some embodiments, the method may also include determining with the host computer system a match level based at least in part on a comparison between at least a portion of the first data set with at least a portion of the second data set. The match level may represent how similar transactions involving different accounts are. In these or other embodiments, the method may also include determining with the host computer system a risk level based at least in part on a comparison between at least a portion of the first data set with at least a portion of the second data set. The risk level may indicate how likely the second transaction is fraudulent. Risk levels may also be determined by analyzing with the host computer system the second data set according to a second set of criteria, and determining with the host computer system a risk level based at least in part on the analysis according to a second set of criteria. The second set of criteria may, merely by way of example, include such criteria as: amount of transaction; time of transaction; location of transaction relative to account holder's home location or last known location; which agent processes the transaction; and time since last or similar transaction. In some embodiments, higher risk levels for a suspect transaction may cause verification of the transaction as fraudulent or non-fraudulent to occur quicker relative to lower risk level suspect transactions.

In some embodiments, the method may also include analyzing with the host computer system a third data set related to a third financial transaction, where the third financial transaction is associated with the second account. The host computer system may then be used to flag the third data set as relating to a fraudulent test transaction. A fraudulent test transaction may be a transaction for minimal value that may be conducted by a party to determine if information related to an account is adequate and/or correct so as to conduct a more significant fraudulent financial transaction by which a greater amount of value can be fraudulently obtained. Because of the minimal value associated with such a transaction, an automated fraud operations system may not identify the transaction quickly, if at all, as a fraudulent transaction, thereby allowing a fraudulent user of the account to verify that a more valuable transaction is possible using the information related to the account. In these embodiments, the method may also include determining with the host computer system a risk level based at least in part on the fraudulent test transaction. The identification of a fraudulent test transaction may increase the risk level associated with a later transaction associated with the same account.

In another embodiment, a method for identifying suspect financial transactions across multiple accounts is provided. The method may include receiving, at a host computer system having a processor, a plurality of data sets, where each data set relates to a financial transaction. The plurality of data sets may include a first data set related to a first financial transaction, where the first financial transaction is associated with a first account; and a second data set related to a second financial transaction, where the second financial transaction is associated with a second account. The method may also include analyzing, with the host computer system, the plurality of data sets according to a first set of criteria, where the analysis indicates that the first financial transaction and second financial transaction are similar. The method may further include using the host computer system to flag the first data set and the second data set as relating to a group of similar transactions. The method may also include determining that the first data set relates to a fraudulent transaction. The method may further include using the host computer system to flag the second data set as relating to a suspect transaction.

In this manner, similar transactions may be identified before, during, or after a fraudulent transaction within the similar transactions is also identified. Transactions that are identified as similar may collectively warrant expedited determinations of whether they are fraudulent, possibly because of the total value of such transactions or other factors. Match levels and risk levels may also be determined for the similar transactions. Match levels for an individual transaction may be determined relative to each of the other similar transactions, or may be determined relative to a mean and/or average transaction for the entire group of similar transactions.

In another embodiment, a system for identifying suspect financial transactions across multiple accounts is provided. The system may include a host computer system and a computer readable medium associate with the host computer system. The computer readable medium may include instructions executable by the host computer system to receive a plurality of data sets, where each data set relates to a financial transaction. The plurality of data sets may include a first data set related to a first financial transaction, where the first financial transaction is associated with a first account; and a second data set related to a second financial transaction, where the second financial transaction is associated with a second account. The computer readable medium may also include instructions executable by the host computer system to flag the first data set as relating to a fraudulent transaction. The computer readable medium may further include instructions executable by the host computer system to analyze the plurality of data sets according to a first set of criteria, where the analysis indicates that the first financial transaction and second financial transaction are similar. The computer readable medium may further include instructions executable by the host computer system to flag the second data set as relating to a suspect transaction.

In some embodiments, the computer readable medium may also have instructions executable by the host computer system to determine a match level based at least in part on a comparison between at least a portion of the first data set with at least a portion of the second data set. In these or other embodiments, the computer readable medium may also have instructions executable by the host computer system to determine a risk level based at least in part on a comparison between at least a portion of the first data set with at least a portion of the second data set. In some embodiments, the computer readable medium may also have instructions executable by the host computer system to analyze the second data set according to a second set of criteria, and determine a risk level based at least in part on the analysis according to a second set of criteria.

In some embodiments, the computer readable medium may also have instructions executable by the host computer system to analyze a third data set related to a third financial transaction, wherein the third financial transaction is associated with the second account, and flag the third data set as relating to a fraudulent test transaction. In these embodiments, the computer readable medium may also have instructions executable by the host computer system to determine a risk level based at least in part on the fraudulent test transaction.

In some embodiments, the computer readable medium may also have instructions executable by the host computer system to determine that the first data set relates to a fraudulent transaction. In these or other embodiments, the computer readable medium may also have instructions executable by the host computer system to receive at the host computer system a notification that the first data set relates to a fraudulent transaction. Some embodiments may also include instructions executable by the host computer system to transmit from the host computer system a notification that the second data set relates to a suspect transaction.

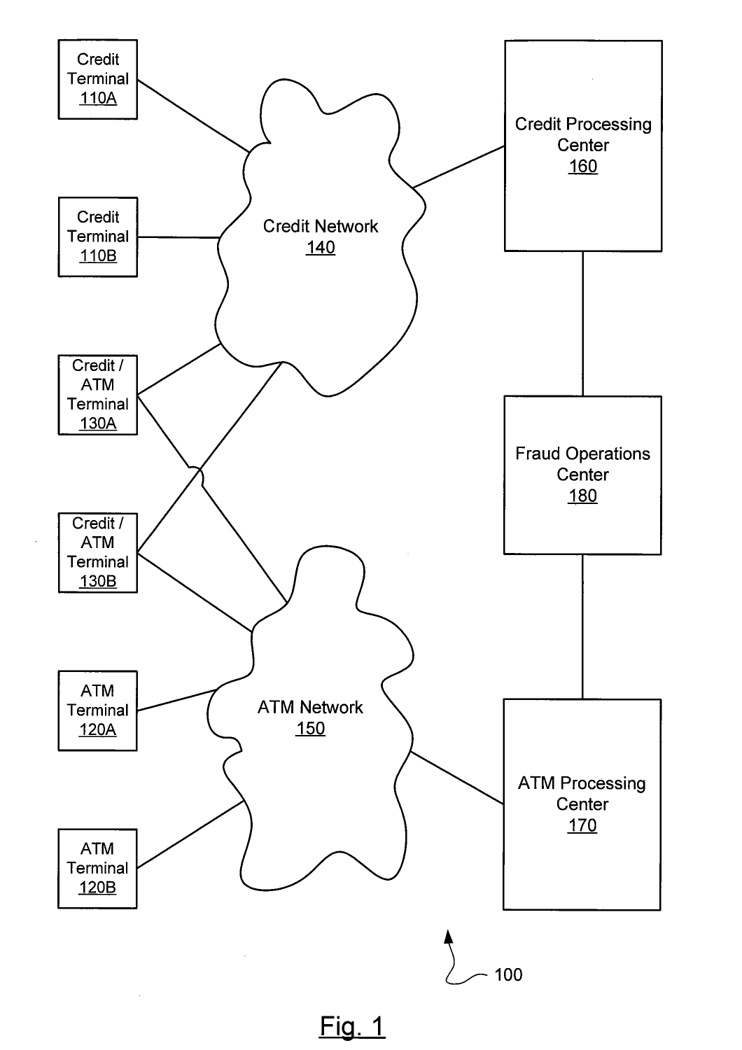

Turning now to FIG. 1, a block diagram of a system 100 of the invention for identifying fraudulent transactions across multiple accounts is shown. System 100 may include credit terminals 110, Automated Teller Machine (“ATM”) terminals 120, and combined credit/ATM terminals 130. Communications from credit terminals 110, ATM terminals 120, and credit/ATM terminals 130 may be transmitted across a credit network 140 and/or an ATM network 150 to credit processing center 160 and/or ATM processing center 170. Credit processing center and ATM processing center may be in communication with fraud operations center 180.

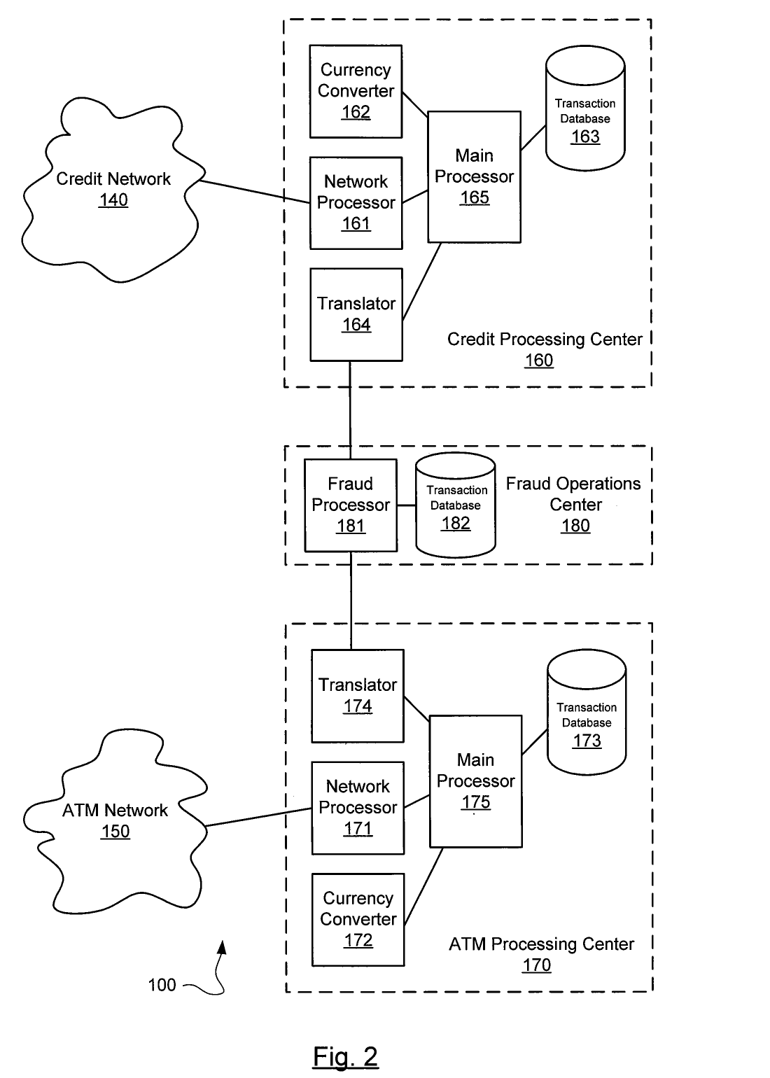

FIG. 2 shows a block diagram of a portion of system 100 shown in FIG. 1, except showing the credit processing center 160, ATM processing center 170, and fraud operations center 180 in more detail. Credit processing center 160 and ATM processing center each include: a network processor 161, 171 to receive and transmit data with their respective networks 140, 150; a currency converter to conduct currency exchange calculations 162, 172; a transaction database 163, 173 to store transaction data, either temporarily or more long-term; a translator 164, 174 to translate and communicate data with fraud operations center 180; and a main processor 165, 175 to process data and direct the operations of each of the other components. Fraud operations center 180 may include a fraud processor 181 and a transaction database 182. All of, or portions of, system 100 may be employed to perform methods of the invention described below to identify fraudulent transactions across multiple accounts, along with other methods and tasks.

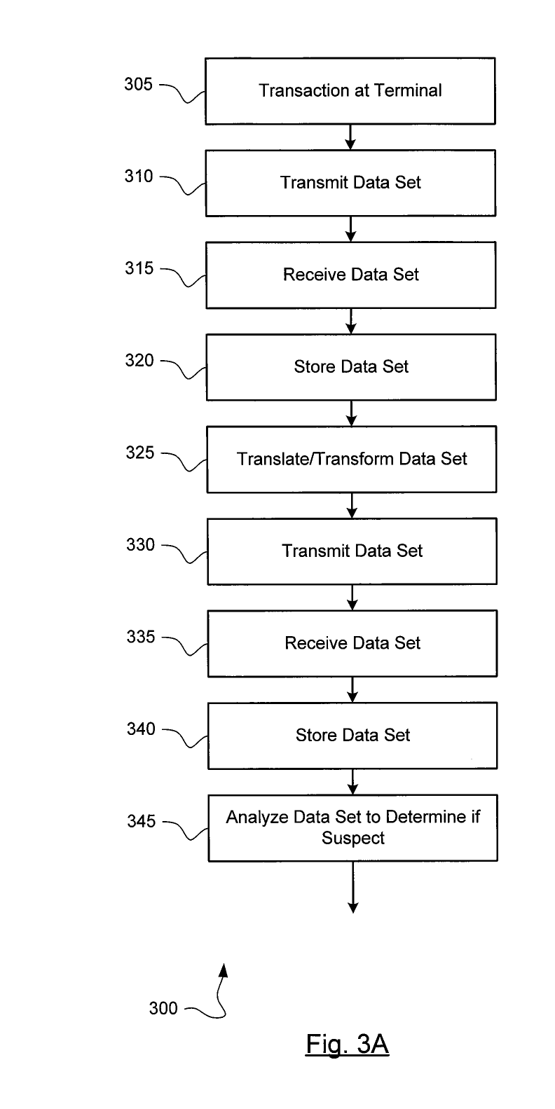

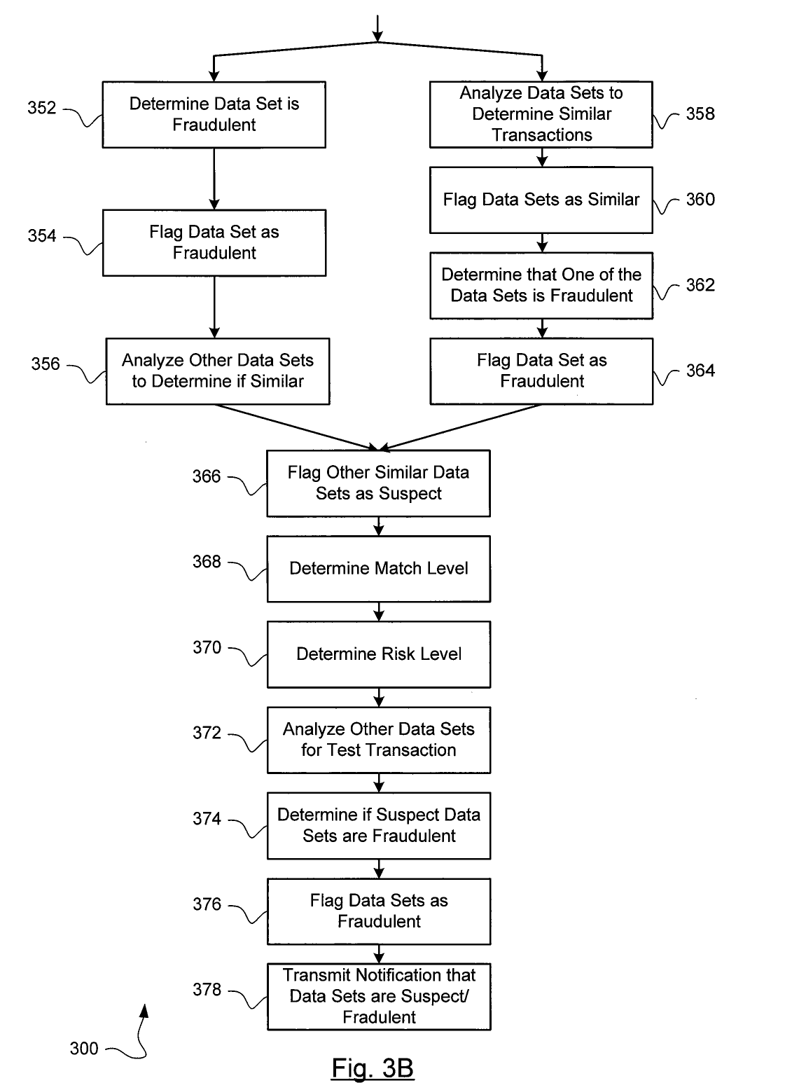

FIG. 3A is the first portion of a flow diagram 300 of a method of the invention for identifying fraudulent transactions across multiple accounts. At block 305, a transaction may occur at a terminal 110, 120, 130. The transaction may not necessarily occur at a traditional point-of-sale (“POS”) terminal, but may occur in another fashion, including, but not limited to, occurring over the internet, or via a telephone call, either automated or person-to-person. In non-traditional transactions, the terminal 110, 120, 130 may be a device or system into which the transaction is either recorded or input.

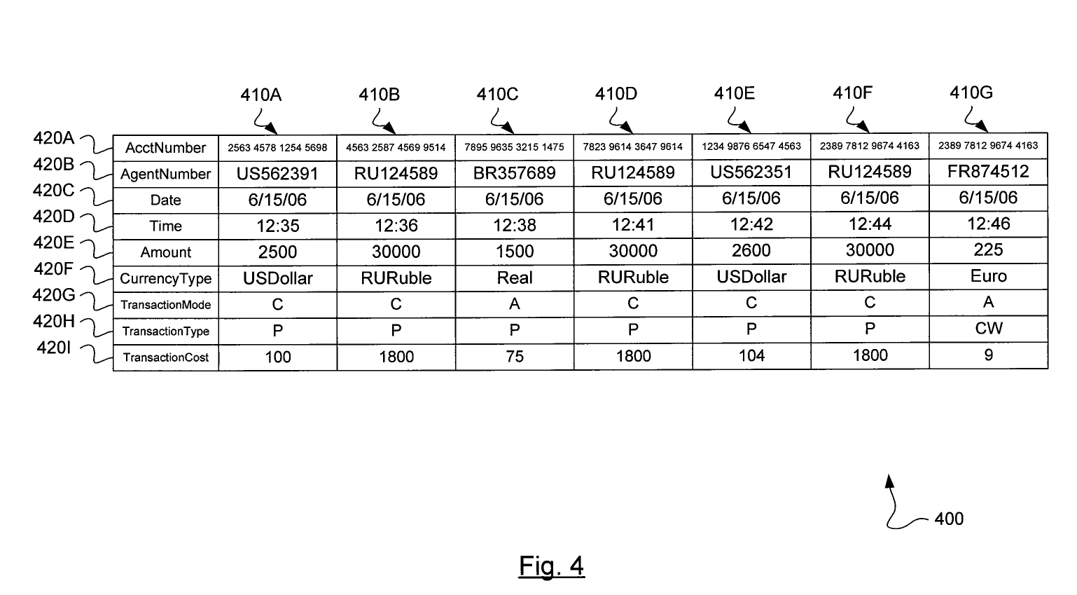

At block 310, a data set representing the transaction may be transmitted from the terminal 110, 120, 130 across either the credit network 140 or ATM network 150 for reception by the credit processing center 160 or ATM processing center 170. Referring to FIG. 4, and merely by way of example, each data set 410 may include such information 420 as an account number 420A of the account from which funds are to be deducted from; an agent number 420B which identifies the person or entity associated charged with operating the terminal 110, 120, 130; a date 420C and time 420D; an amount 420E of the transaction; a type of currency 420F the transaction occurred in; a transaction mode 420G of the transaction; a transaction type 420H (for example, whether the transaction is a credit or an ATM transaction); and a processing cost 4201 of the transaction. The data sets 410 shown in FIG. 4 show both credit and ATM transactions, and are combined here merely for the purpose of explanation. In practice, the credit transactions may be transmitted only through credit network 140 to credit processing center 160, and the ATM transactions may be transmitted only through ATM network 150 to ATM processing center 170.

At block 315, data set 410 may be received by network processor 161, 171. At block 320, main processor 165,175 may direct data set 410 to be stored in transaction database 163, 173. In some embodiments, some of this information 420 may not be added to the data set until it reaches the credit processing center 160 or ATM processing center 170. Merely by way of example, the processing center 160, 170 may add date 420C and time 420G information to the data set 410 when it is received; assign a currency type 420F to the data set 410 based on the location of the agent as determined by the agent number 420B; and/or calculate the transaction cost 4201 when the data set 410 is received.

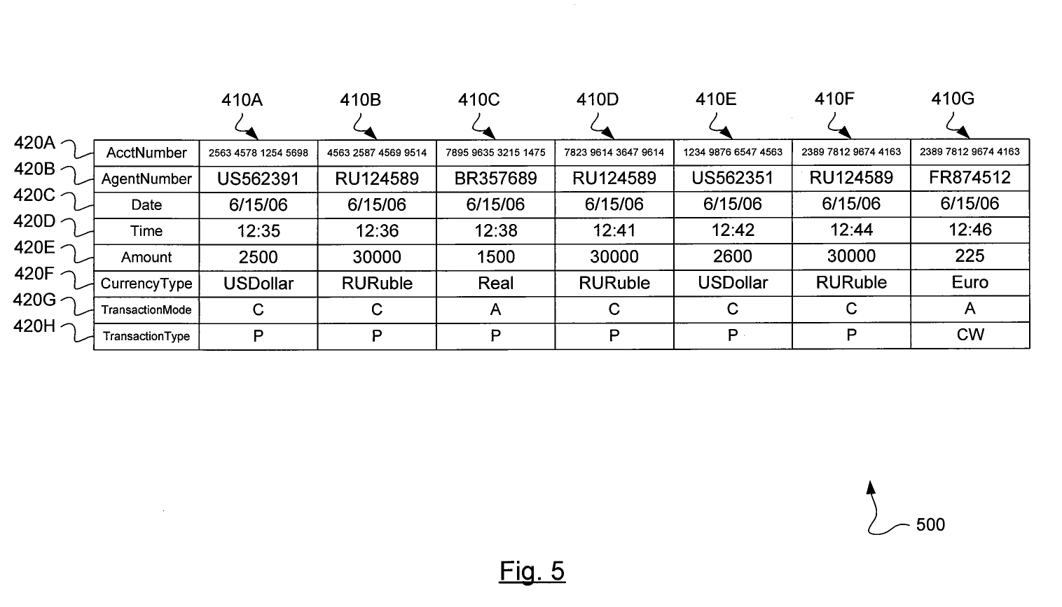

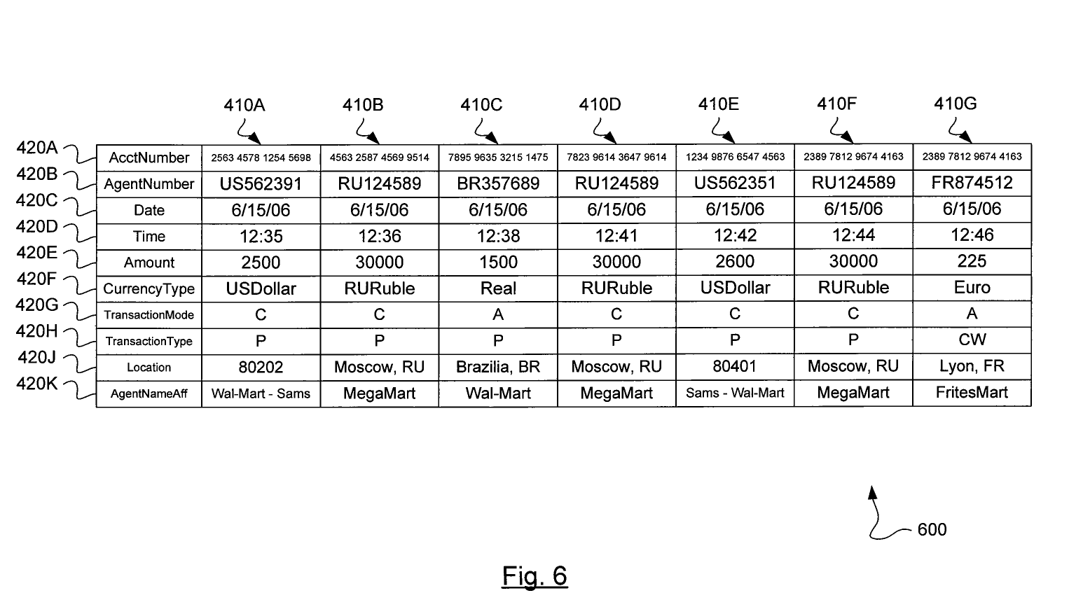

At block 325, the data sets 420 may be translated and/or transformed by translator 164, 174. Translation and transformation may include stripping data sets 410 of information 420 which may not be useful for fraud checking purposes, and/or adding information 420 which may be useful for fraud checking purposes. Merely by way of example, FIG. 5 shows the data sets 410 from FIG. 4, but with the transaction cost 420I field removed. In FIG. 6, additional information 420 fields have been added to data sets 410. In this example, a location 420J field and an agent name and affiliation 420K have been added. An affiliation may be a relationship between parent and subsidiary agents which may be significant when analyzing data sets 410 for fraud. The main processor 165, 175 may direct the translator 164, 174 to add this information 420 based at least on other information 420 already contained in the data sets 410. To do this, main processor 165, 175 and/or translator 164, 174 may be in communication with data stores containing additional data.

Merely by way of example, main processor 165, 175 and/or translator 164, 174 may cross-reference the agent number 420B field, or any other field, of each data set 410 to determine additional information 420 which may be useful for fraud checking purposes. In the example shown in FIG. 6, a location 420J field and an agent name and affiliation 420K have been added through determining what location and agent name and affiliation are associated with the agent number 420B of each data set 410. As with any other information 420 field, the location 420J and agent name and affiliation 420K field may be either descriptive or coded. For example, an alpha-numeric code may represent a location or the actual location name can be presented. In data set 410A, location 420J field can be viewed as either descriptive or coded. If the “80202” represents a postal zip code, then the field is descriptive, but if the “80202” is derived from an internal, possibly proprietary, location coding scheme, then the location 420J field may be viewed as coded. An example of coded information 420 fields may include transaction mode 420G and transaction type 420H. In the transaction mode 420G fields, a “C” may indicate a credit mode transaction, while an “A” may indicate an ATM mode transaction. Likewise, in the transaction type 420H field, a “P” may indicate a purchase of goods, a “CW” may indicate a cash withdrawal. Other codes may also exist such as “I” for internet purchase or “S” for services purchase.

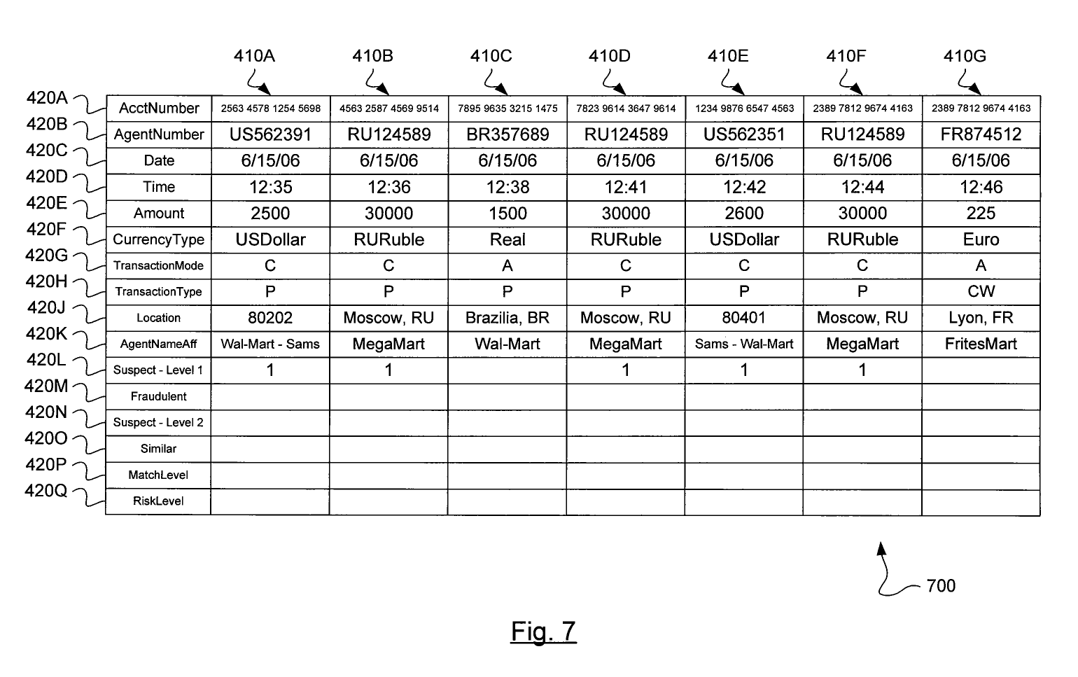

Referring back to FIG. 3A, at block 330, translator 164, 174 may transmit the data sets 410 to fraud operations center 180, possibly for reception by fraud processor 181. At block 335, fraud processor 181 may receive data sets 410 and store them on transaction database 182 at block 340. At block 345, the data sets 410 may be analyzed by fraud processor 174 to determine if they relate to suspect transactions. Merely by way of example, and using various criteria such as past spending patterns; time and amount of current transaction; and other information, fraud processor 174 may find individual data sets 410 as relating to suspect transactions. Turning to FIG. 7, data set 410A, data set 410B, data set 410D, data set 410E, and data set 410F have been flagged in transaction database 182 by fraud processor 181 as relating to suspect transactions. A field 420, possibly referred to as “suspect—level 1” field 420L, within each data set 410 may record the flag. Merely by way of example, data set 410A may be flagged as suspect in step 345 because of the unusual amount 420E of the transaction when compared to past spending trends associated with the account; data set 410B may be flagged as suspect in step 345 because of the unusual amount 420E of the transaction, as well as its unusual location 420J when compared to prior transactions associated with the account; data set 420D may be flagged as suspect and its debt 345 because of the unusual amount 420E of the transaction, as well as its unusual location 420J when compared to prior transactions associated with the account; data set 410E may be flagged as suspect in step 345 because of the unusual amount 420E of the transaction when compared to past spending trends associated with the account; and data set 420F may be flagged as suspect and its debt 345 because of the unusual amount 420E of the transaction, as well as its unusual location 420J when compared to prior transactions associated with the account. In some embodiments, portfolio spending may also be analyzed to determined if spending trends on other accounts related to the subject account, for example, because they are both held by the same person or institution, indicate that a transaction may be suspect.

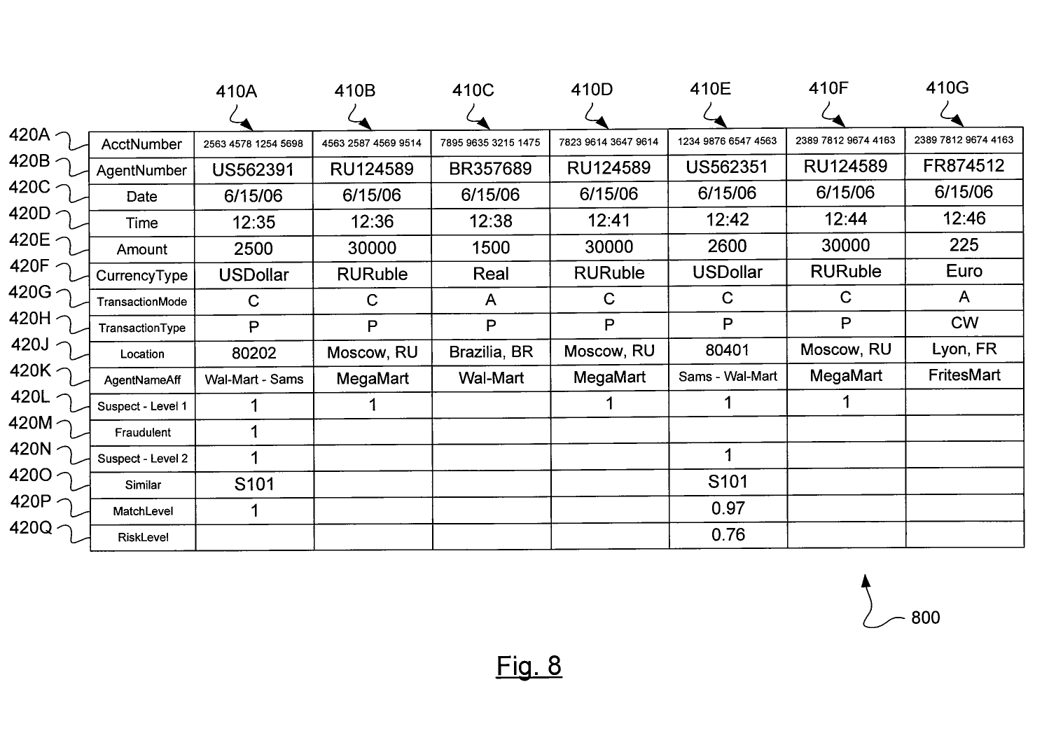

Continuing on to FIG. 3B, two possible method embodiments of the invention are shown. Employing one method, at block 352, data sets 410 may be determined to be fraudulent. In some embodiments, a person may verify with the account holder that the first data set relates to a fraudulent transaction, possibly over the phone or via electronic transmission such as e-mail. In some embodiments, an automated system may be used to call or electronically contact the account holder, possibly via e-mail or text message. As shown in FIG. 8, data set 410A may be determined to be fraudulent and flagged at block 354 (note the flag in fraudulent 420M field).

Fraud processor 181 may then analyze other data sets to determine if they are similar at block 356. In this example, the fraud processor 181 may determine that data set 410A and data set 410E are similar for multiple reasons, possibly including any one of, or combination of: (1) their amounts 420E are within a certain range, merely by way example, less than a 5% difference; (2) the transactions are only 7 minutes apart in time 420E; (3) the transaction mode 420G and transaction type 420H are the same; (4) the locations 420J are relatively close (80202 may represent a zip code being Denver, Colo., USA, and 80401 may represent a zip code being Golden, Colo., USA, a suburb of Denver); and (5) an affiliation relationship 420K between the agents in the two transactions.

As discussed above, possible comparisons that may be made include: a monetary amount specified by the first data set being within a certain range of a monetary amount specified by the second data set; a transaction mode specified by the first data set being the same as, or related to, a transaction mode specified by the second data set; a type of transaction specified by the first data set being the same as, or related to, a type of transaction specified by the second data set; a geographic location specified by the first data set being within a certain distance of a geographic location specified by the second data set; an agent identifier specified by the first data set being the same as, or related to, an agent identifier specified by the second data set; a date specified by the first data set being within a certain range of a date specified by the second data set; and a time specified by the first data set being within a certain range of a time specified by the second data set.

Based on the comparison of data sets 410, data set 410A and data set 410E may be flagged as similar. As shown in FIG. 8, an identifying flag ‘S101’ may be stored in similar 420O information field for each data set 410. In this manner, another process may easily later determine that each of the transactions is similar to the other. At block 366, the data set may be flagged as being suspect in the “suspect—level 2” data field 420N. It may now be appreciated that while “suspect—level 1” indicates suspicion due to unusual activity within the transactions of an individual account, “suspect—level 2” indicates suspicion due to similar unusual activity occurring on multiple different accounts.

At block 368, a match level 420P may be determined for the similar data sets 410A, 410E. Match level 420P may be a function of information 420 in each similar data set 410A, 410E. In this example, match level 420P for data set 410E may be 97% (0.97) when compared to data set 410A. At block 370, a risk level 420Q may be determined for the similar data set 410E. A risk level may, in some embodiments, not be determined for data set 410A because it has already been determined to be fraudulent. Risk level 420Q may be a function of information 420 in each similar data set 410A, 410E, or merely of information 420 in only data set 410E. In some embodiments, the amount 420E of the transaction may be more determinative of risk level 420Q than other information 420 in data set 410E.

In some embodiments, the existence of contractual agreements which may determine liability between the agent and the financial institution handling the transaction may also contribute to determining risk level. Merely by way of example, if under a contractual agreement, the agent shall bear more liability for fraudulent activity occurring via one of the agent's terminals, then risk level 420Q may be lower, proportionally than if the financial institution handing the transaction did not have a contractual agreement with such terms in place with the agent.

At block 372, fraud processor 181 may analyze other data sets 410 in transaction database 182 to determine if a test transaction has been processed using the same account (and corresponding account number 420A). A test transaction may be a transaction for minimal value that may be conducted by a party to determine if information related to an account is adequate and/or correct so as to conduct a more significant fraudulent financial transaction by which a greater amount of value can be fraudulently obtained. Because of the minimal value associated with such a transaction, an automated fraud operations system may not identify the transaction quickly, if at all, as a fraudulent transaction, thereby allowing a fraudulent user of the account to verify that a more valuable transaction is possible using the information related to the account. In some embodiments, the method may also include determining with the fraud processor 181 a risk level based at least in part on the fraudulent test transaction. The identification of a fraudulent test transaction may increase the risk level 420Q associated with transactions associated with the same account.

At block 374, fraud processor 181, or a person or system in communication with fraud processor 181 may determine whether or not data sets 410 are related to fraudulent transactions. In some embodiments, a person may verify with the account holder that the data set 410 relates to a fraudulent transaction, possibly over the phone or via electronic transmission such as e-mail. In other embodiments, an automated system may be used to call or electronically contact the account holder. In some embodiments, if the match level 420P and/or risk level 420Q are above a certain threshold, fraud processor 181 may automatically determine that a given data set 410 is fraudulent. At block 376, fraud processor 181 may flag any data set 410 determined to be fraudulent. At block 378, fraud processor 181 may cause a notification of fraudulent activity to be transmitted. The notification may possibly be for receipt by a network processor 161, 171 at either credit processing center 160 or ATM processing center 170. Network processor 161, 171 may take an action, or direct another system to take an action based on the notification, such as suspend the account, decline similar transactions for a particular period of time, and/or notify law enforcement authorities.

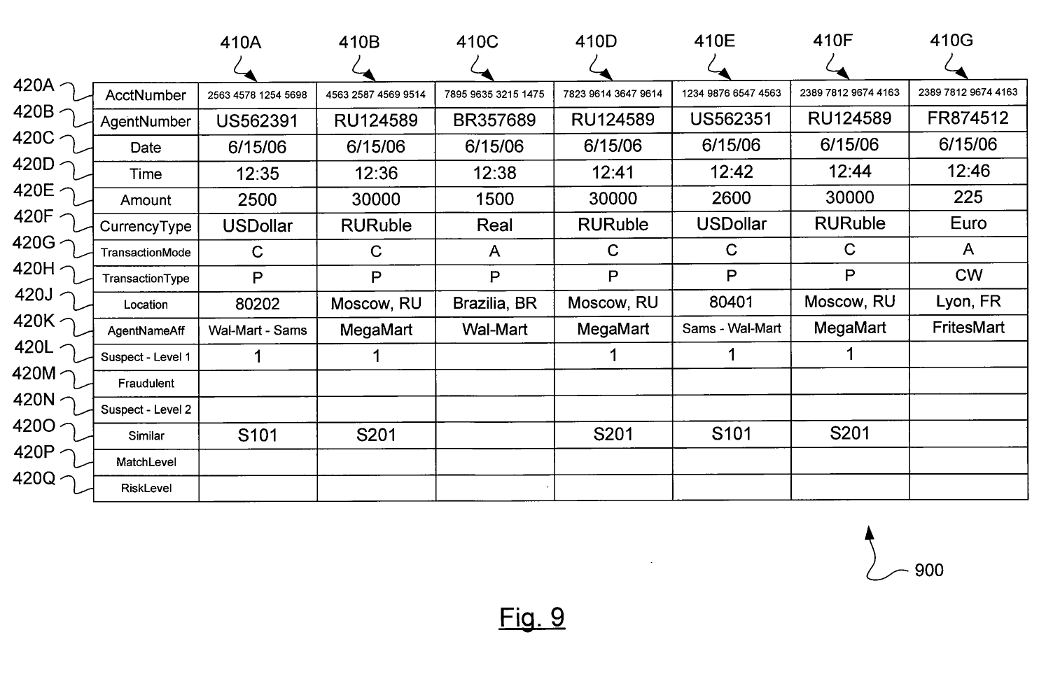

In another embodiment, before one or more transactions are determined to be fraudulent, fraud processor 181 may use another method to determine if transactions are suspect. As seen in FIG. 3B, after the data sets 410 are received by fraud processor 181 and analyzed individually for ‘suspect—level 1’ status, fraud processor 181 may analyze a plurality of data sets 410 to determine if any are similar to others at block 358. At block 360, data sets 410 which are similar are flagged in groups. Turning to FIG. 9, it is seen how data set 410A and data set 410E may be flagged as being similar with the ‘S101’ flag. Additionally, data sets 410B, 420D, 410F have been flagged as similar to each other with the ‘S201’ flag. After or during the process of flagging data sets 410 as similar, groups of similar data sets 410 displaying similarities may warrant expedited determination of checking whether they are fraudulent at block 362. In some embodiments, if match level 420P and/or risk level 420Q are above a certain threshold, then similar data sets 410 may automatically flagged as fraudulent. Fraudulent transactions will be flagged as fraudulent at block 364, and fraud processor 181 will continue the process as discussed above and shown in FIG. 3B.

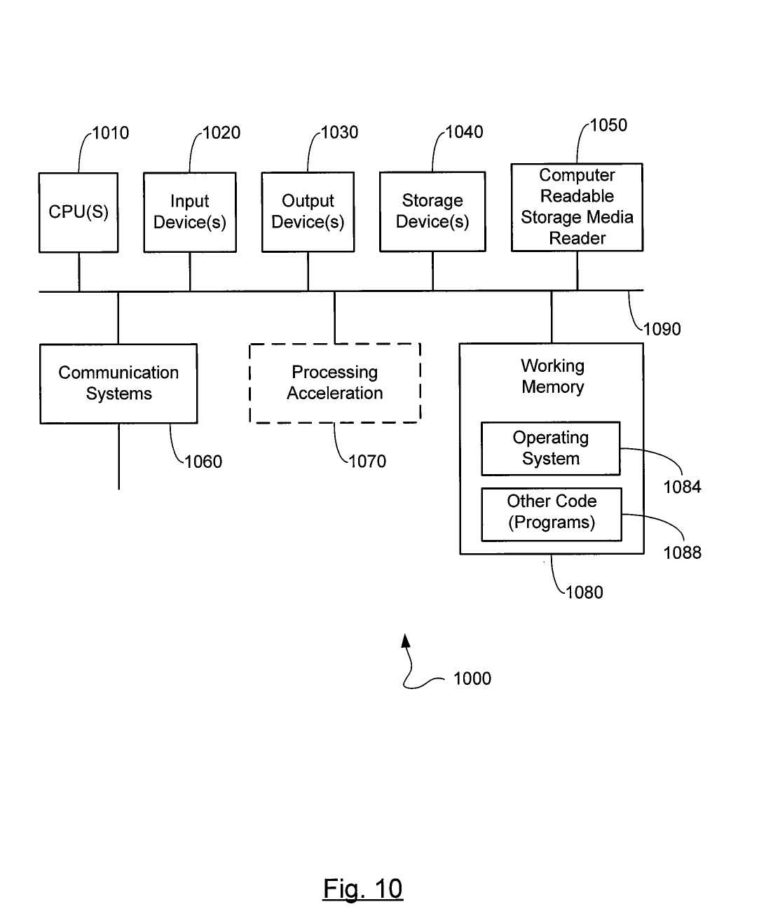

FIG. 10 is a block diagram illustrating an exemplary computer system 1000 in which embodiments of the present invention may be implemented. This example illustrates a computer system 1000 such as may be used, in whole, in part, or with various modifications, to provide the functions of credit processing center 160, the ATM processing center 170, network processor 161, 171, currency converter 162,172, transaction database 136, 173, 182, translator 164, 174, main processor 165, 175 and/or other components of the invention such as those discussed above. For example, various functions of the fraud processor 181 may be controlled by the computer system 1000, including, merely by way of example, analyzing similarities between data sets 410, determining match levels 420P, determining risk levels 420Q, flagging data sets 410, etc.

The computer system 1000 is shown comprising hardware elements that may be electrically coupled via a bus 1090. The hardware elements may include one or more central processing units 1010, one or more input devices 1020 (e.g., a mouse, a keyboard, etc.), and one or more output devices 1030 (e.g., a display device, a printer, etc.). The computer system 1000 may also include one or more storage device 1040. By way of example, storage device(s) 1040 may be disk drives, optical storage devices, solid-state storage device such as a random access memory (“RAM”) and/or a read-only memory (“ROM”), which can be programmable, flash-updateable and/or the like.

The computer system 1000 may additionally include a computer-readable storage media reader 1050, a communications system 1060 (e.g., a modem, a network card (wireless or wired), an infra-red communication device, Blutetooth™ device, cellular communication device, etc.), and working memory 1080, which may include RAM and ROM devices as described above. In some embodiments, the computer system 1000 may also include a processing acceleration unit 1070, which can include a digital signal processor, a special-purpose processor and/or the like.

The computer-readable storage media reader 1050 can further be connected to a computer-readable storage medium, together (and, optionally, in combination with storage device(s) 1040) comprehensively representing remote, local, fixed, and/or removable storage devices plus storage media for temporarily and/or more permanently containing computer-readable information. The communications system 1060 may permit data to be exchanged with a network, system, computer and/or other component described above.

The computer system 1000 may also comprise software elements, shown as being currently located within a working memory 1080, including an operating system 1084 and/or other code 1088. It should be appreciated that alternate embodiments of a computer system 1000 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 1000 may include code 1088 for implementing any or all of the function of the various elements of the architecture as described herein. For example, software, stored on and/or executed by a computer system such as system 1000, can provide the functions of the credit processing center 160, the ATM processing center 170, network processor 161, 171, currency converter 162,172, transaction database 136, 173, 182, translator 164, 174, main processor 165, 175 and/or other components of the invention such as those discussed above. Methods implementable by software on some of these components have been discussed above in more detail.

A number of variations and modifications of the invention can also be used within the scope of the invention. For example, various steps of the methods discussed herein can be conducted by multiple processors in different orders than shown in FIG. 3A and FIG. 3B. Merely by way of example, resources which are relied on to determine whether a transaction is fraudulent, such as phone banks of fraud specialists, may prioritize their determination of whether transactions are indeed fraudulent based on the, match level, risk level, and number of similar transactions. Additionally, in some embodiments, transactions may be verified as fraudulent, or not, in the order they are received by fraud processor 181, with changes in that order reflecting detections of similarities between transaction which have been found either similar to other fraudulent or non fraudulent transactions.

The invention has now been described in detail for the purposes of clarity and understanding. However, it will be appreciated that certain changes and modifications may be practiced within the scope of the appended claims.

What is claimed is:

1. A method for identifying suspect financial transactions across multiple accounts, wherein the method comprises:
receiving at a host computer system having a processor a plurality of data sets, wherein each data set relates to a financial transaction, and wherein the plurality of data sets comprise:
a first data set related to a first financial transaction, wherein the first financial transaction is associated with a first account; and
a second data set related to a second financial transaction, wherein the second financial transaction is associated with a second account;
using the host computer system, flagging the first data set as relating to a fraudulent transaction;
analyzing with the host computer system the plurality of data sets according to a first set of criteria, wherein the analysis indicates that the first financial transaction and second financial transaction are similar; and
using the host computer system, flagging the second data set as relating to a suspect transaction.

2. The method of claim 1, wherein the method further comprises determining with the host computer system a match level based at least in part on a comparison between at least a portion of the first data set with at least a portion of the second data set.

3. The method of claim 1, wherein the method further comprises determining with the host computer system a risk level based at least in part on a comparison between at least a portion of the first data set with at least a portion of the second data set.

4. The method of claim 1, wherein the method further comprises:
analyzing with the host computer system the second data set according to a second set of criteria; and
determining with the host computer system a risk level based at least in part on the analysis according to a second set of criteria.

5. The method of claim 1, wherein the method further comprises:
analyzing with the host computer system a third data set related to a third financial transaction, wherein the third financial transaction is associated with the second account; and
using the host computer system, flagging the third data set as relating to a fraudulent test transaction.

6. The method of claim 5, wherein the method further comprises determining with the host computer system a risk level based at least in part on the fraudulent test transaction.

7. The method of claim 1, wherein the method further comprises determining with the host computer system that the first data set relates to a fraudulent transaction.

8. The method of claim 1, wherein the method further comprises receiving at the host computer system a notification that the first data set relates to a fraudulent transaction.

9. The method of claim 1, wherein the method further comprises transmitting from the host computer system a notification that the second data set relates to a suspect transaction.

10. The method of claim 1, wherein each data set comprises information, wherein the information is selected from a group consisting of:
an account identifier;
a monetary amount;
a transaction mode;
a type of transaction;
a geographic location;
an agent identifier;
a date; and
a time.

11. The method of claim 1, wherein each financial transaction comprises a type of transaction, wherein the type of transaction is selected from a group consisting of:
a cash withdrawal;
a transfer of value;
a purchase of goods; and
a purchase of services.

12. The method of claim 1, wherein the first set of criteria comprises an individual criteria, wherein the individual criteria is selected from a group consisting of:
a monetary amount specified by the first data set is within a certain range of a monetary amount specified by the second data set;
a transaction mode specified by the first data set is the same as, or related to, a transaction mode specified by the second data set;
a type of transaction specified by the first data set is the same as, or related to, a type of transaction specified by the second data set;
a geographic location specified by the first data set is within a certain distance of a geographic location specified by the second data set;
an agent identifier specified by the first data set is the same as, or related to, an agent identifier specified by the second data set;
a date specified by the first data set is within a certain range of a date specified by the second data set; and
a time specified by the first data set is within a certain range of a time specified by the second data set.

13. A method for identifying suspect financial transactions across multiple accounts, wherein the method comprises:
receiving at a host computer system having a processor a plurality of data sets, wherein each data set related to a financial transaction, and wherein the plurality of data sets comprise:
a first data set related to a first financial transaction, wherein the first financial transaction is associated with a first account; and
a second data set related to a second financial transaction, wherein the second financial transaction is associated with a second account;
analyzing with the host computer system the plurality of data sets according to a first set of criteria, wherein the analysis indicates that the first financial transaction and second financial transaction are similar; and
using the host computer system, flagging the first data set as relating to a group of similar transactions;
using the host computer system, flagging the second data set as relating to the group of similar transactions;
determining that the first data set relates to a fraudulent transaction; and
using the host computer system, flagging the second data set as relating to a suspect transaction.

14. The method of claim 13, wherein the method further comprises determining with the host computer system a match level based at least in part on a comparison between at least a portion of the first data set with at least a portion of the second data set.

15. The method of claim 13, wherein the method further comprises determining with the host computer system a risk level based at least in part on a comparison between at least a portion of the first data set with at least a portion of the second data set.

16. The method of claim 13, wherein the method further comprises:
analyzing with the host computer system the second data set according to a second set of criteria; and
determining with the host computer system a risk level based at least in part on the analysis according to a second set of criteria.

17. The method of claim 13, wherein the method further comprises:
analyzing with the host computer system a third data set related to a third financial transaction, wherein the third financial transaction is associated with the second account; and
using the host computer system, flagging the third data set as relating to a fraudulent test transaction.

18. The method of claim 17, wherein the method further comprises determining with the host computer system a risk level based at least in part on the fraudulent test transaction.

19. A system for identifying suspect financial transactions across multiple accounts, wherein the system comprises:
a host computer system;
a computer readable medium associated with the host computer system, wherein the computer readable medium comprises instructions executable by the host computer system to:
receive a plurality of data sets, wherein each data set relates to a financial transaction, and wherein the plurality of data sets comprise:
a first data set related to a first financial transaction, wherein the first financial transaction is associated with a first account; and
a second data set related to a second financial transaction, wherein the second financial transaction is associated with a second account;
flag the first data set as relating to a fraudulent transaction;
analyze the plurality of data sets according to a first set of criteria, wherein the analysis indicates that the first financial transaction and second financial transaction are similar; and
flag the second data set as relating to a suspect transaction.

20. The system of claim 19, wherein the computer readable medium further comprises instructions executable by the host computer system to determine a match level based at least in part on a comparison between at least a portion of the first data set with at least a portion of the second data set.
